(19) United States
(12) Patent Application Publication
(10) Pub. No.: US 2012/0248905 A1
(43) Pub. Date: Oct. 4, 2012

(54) ELECTRIC DRIVE UNIT

(75) Inventors: Katharina BURKART, Graz (AT); Franz MAYR, St. Marein bei Graz (AT); Daniel PRIX, Ebental (AT)

(73) Assignee: MAGNA Powertrain AG & Co KG, Lannach (AT)

(21) Appl. No.: 13/429,488

(22) Filed: Mar. 26, 2012

(30) Foreign Application Priority Data
Mar. 31, 2011 (DE) 10 2011 015 623.2

(51) Int. Cl. H02K 9/19

(52) U.S. Cl. 310/54

(57) ABSTRACT

An electric drive unit for a motor vehicle has an electric machine and a lubrication and cooling circuit. The lubrication and cooling circuit includes an aqueous lubricant, which is passed at least through an internal area of the electric machine, in order to cool parts of the electric machine in the internal area.

### CROSS-REFERENCE TO RELATED APPLICATIONS

The present application claims priority under 35 U.S.C. §119 to German Patent Application No. 10 2011 015 623.2 (filed on Mar. 31, 2011), which is hereby incorporated by reference in its entirety.

### FIELD OF THE INVENTION

The invention relates to an electric drive unit for a motor vehicle, in particular an electric axle drive unit, having an electric machine The electric machine includes a lubrication and cooling circuit for the electric machine.

### BACKGROUND OF THE INVENTION

An electric drive unit may be used as an autonomous drive source for a motor vehicle, such as a pure electric drive on one axle. Alternatively, a drive unit such as this may be intended to assist a main drive unit, in particular to assist an internal combustion engine (hybrid drive). Typically, the electric machine is, for example, in the form of a polyphase asynchronous motor or a permanent-magnet synchronous machine. By way of example, a rotor of the electric machine may drive an input element of an axle differential gearbox whereby, if required, a speed-changing gearbox can additionally be provided between the electric machine and the axle differential gearbox, in order to slow down the rotation speed of the rotor of the electric machine.

A high power density is desirable for an electric drive unit such as this, in order to allow as high a drive power as possible to be produced in a given physical area. During operation, the electric machine produces additional heat, which should be dissipated as effectively as possible. In this case, efficient cooling of the electric machine is of major importance, since efficient cooling makes it possible to significantly increase the power output of the electric machine (that is to say the efficiency). Conversely, this means that the electric components require a smaller physical space to achieve a specific drive power.

If the electric machine is followed by a gearbox, for example, in the case of an axle drive unit with an axle differential gearbox, the gearbox should also be cooled. In particular, however, the gearbox must be lubricated, in which case a lubrication circuit for a gearbox is subject to different requirements than those for a cooling circuit for an electric machine. In a situation such as this, it is admittedly possible to lubricate and to cool the electric machine and the gearbox by way of a common lubricating-oil circuit, in such a case, the electric machine is provided with a special winding, for example, in order to enlarge the surface area and in this way to improve the heat dissipation. However, such a design is undesirably complex and, in the end, the low thermal capacity of lubricating oil nevertheless limits the achievable heat dissipation.

### SUMMARY OF THE INVENTION

An object of the invention is to provide an enhanced lubrication and cooling system for an electric drive unit as noted hereinabove, which allows the electric machine to have a higher power density, in particular with respect to the small physical space available for an axle drive unit.

In accordance with embodiments, the electric drive unit includes at least one of: an electric motor including a rotor and a stator; and a lubrication and cooling circuit configured for circulation through the electric motor, the lubrication and cooling circuit having a first fluid which is flows through and contacts an internal area of the electric motor to thereby lubricate and cool the internal area.

In accordance with embodiments, the electric drive unit includes at least one of: an electric motor including a rotor, a stator, an inverter and a gearbox; a first fluid circuit configured to lubrication and cool a first predetermined area of the electric motor; and a second fluid circuit configured to cool a second predetermined area of the electric motor. The second fluid circuit is operated at a lower temperature level than a temperature level of the first fluid circuit.

In accordance with embodiments, the electric drive unit includes at least one of: an electric motor including a rotor, a stator, an inverter and a gearbox; a first fluid circuit configured to lubricate and cool the electric motor, the first fluid circuit comprising a first fluid circuit feed device which circulates a first fluid continuously through the first fluid circuit, and a first fluid/air heat exchanger; and a second fluid circuit configured to cool the electric motor, the second fluid circuit comprising a second fluid circuit feed device which circulates a second fluid continuously through the second fluid circuit, and a second fluid/air heat exchanger. The first fluid circuit extends continuously between the first fluid circuit feed device, at least one of the stator and the rotor, the first heat exchanger and the gearbox, while the second fluid circuit extends continuously between the second fluid circuit feed device, the second heat exchanger, the inverter, the first heat exchanger and the stator.

Therefore, the electric drive unit includes a lubrication and cooling circuit having an aqueous lubricant, such as a mixture of water and at least one additional substance (for example, an alcohol). In particular, the aqueous lubricant may have a water-glycol mixture. The water component of the lubricant is used for particularly effective cooling of the internal area of the electric machine. For this purpose, the aqueous lubricant is passed along parts of the internal area of the electric machine. The heat emitted by the electric machine can therefore be absorbed and dissipated particularly effectively, in particular also in combination with cooling of the outer face of the electric machine as well since the waste heat is created mainly in the internal area of the electric machine. In addition, the aqueous lubricant can lubricate other areas of the electric machine, for example, the bearings of the electric machine.

In comparison to a typical lubricant, water has a high heat capacity, a high thermal conductivity and a correspondingly high heat transfer coefficient. The aqueous lubricant can therefore absorb and dissipate a comparatively large amount of thermal heat from the electric machine. No particular requirements need be placed on the heat transfer surfaces for this purpose, thus making it possible to achieve a high power density in the electric machine, that is to say a high efficiency, with the electric drive unit being of simple and compact design.

Advantageous embodiments of the invention are provided. For instance, for particularly effective cooling of the internal area of the electric machine, it is preferable that the aqueous lubricant is passed along an inner envelope surface of a stator of the electric machine. In particular, the aqueous lubricant can be passed by the winding ends of the electric machine, in order to absorb and dissipate a large amount of thermal heat.

Alternatively or additionally, the aqueous lubricant can be passed along an outer envelope surface of a rotor of the electric machine, which is stored within a stator. Alternatively or additionally, the aqueous lubricant can also be passed through axial and/or radial cooling channels in the rotor (with respect to the rotation axis of the electric machine) in order to achieve as high an efficiency as possible in respect of absorption and dissipation of waste heat.

In accordance with embodiments of the invention, the drive unit may further include an inverter which is electrically connected upstream of the electric machine, and a dedicated cooling circuit for the inverter. In such an embodiment, the lubrication and cooling circuit for the electric machine and the cooling circuit for the inverter are thermally coupled to one another via a heat exchanger. This allows the electric components to be cooled to two separate (and different) temperature levels, for example, a lower temperature level can be provided in the cooling circuit for the inverter than in the lubrication and cooling circuit for the electric machine. This allows the electric machine to be operated with high efficiency, while the associated inverter is nevertheless reliably protected against overheating. Because of the heat exchange link between them, the cooling circuit of the inverter can also be used to cool the aqueous lubricant in the lubrication and cooling circuit.

The cooling circuit for the inverter preferably includes cooling water which is passed along parts of the inverter. Because of the high thermal capacity and thermal conductivity of the cooling water, its use results in particularly effective cooling of the inverter and also, via the heat exchanger, the aqueous lubricant in the lubrication and cooling circuit.

The cooling water in the cooling circuit for the inverter may in one advantageous embodiment also be passed along parts of the electric machine, in order to assist the cooling that area. In particular, the cooling water in the cooling circuit of the inverter may be passed on the outer face of the electric machine, for example, along an outer envelope surface of a stator of the electric machine. The cooling circuit can in this way additionally form an outer cooling jacket for the electric machine.

In accordance with embodiments of the invention, the drive unit includes an inverter which is electrically connected upstream of the electric machine, whereby the aqueous lubricant in the lubrication and cooling circuit is also passed along parts of the inverter in order to cool the inverter. Therefore, in such an embodiment, no additional cooling circuit is provided with a heat exchange connection to the aqueous lubricant, thus simplifying the design of the electric drive unit and making it possible to achieve an even smaller physical size.

In addition, in such an embodiment it is advantageous for the aqueous lubricant in the lubrication and cooling circuit also to be passed along an outer face of the electric machine, for example, along the outer envelope surface of a stator, in order to additionally absorb and dissipate heat emitted therefrom.

For all of the abovementioned embodiments, it is preferable for the drive unit to also include a gearbox which is mechanically coupled to an output of the electric machine (for example, the rotor), whereby the aqueous lubricant in the lubrication and cooling circuit not only cools the internal area of the electric machine but is also passed along parts of the gearbox, in order to cool and to lubricate the gearbox. This therefore achieves an optimum compromise for the specific requirements of an electric drive unit with an electric machine followed by a gearbox, by the use of an aqueous lubricant, in order to allow the electric machine to have a high power density. The gearbox is preferably an axle differential gearbox, which is coupled on the input side to the electric machine, optionally via an additional speed-changing gearbox. In general, the gearbox which is coupled to the electric machine may be a revolving gearbox or a stationary gearbox.

The aqueous lubricant preferably has a low electric conductivity such that this allows a continuous electric current flow via at least one bearing of the electric machine. In other words, a low electric conductivity of the aqueous lubricant allows an electric current (caused by the design configuration of the electric machine) to flow continuously, flowing via the bearing of the electric machine (corresponding to a reduced internal resistance of the bearing itself). This prevents electric discharges in the bearing, and therefore the destruction of the bearing surfaces.

In all of the abovementioned embodiments, the lubrication and cooling circuit of the electric drive unit may furthermore have a heat exchanger via which the aqueous lubricant emits heat to the surrounding area. By way of example, this heat exchanger may include cooling ribs on a housing outer face in order to emit waste heat from the aqueous lubricant to the surrounding area, by way of a thermally conductive connection.

### BRIEF DESCRIPTION OF THE DRAWINGS

Embodiments of the invention will be explained in the following text purely by way of example with reference to the drawings. The same elements or elements of the same type are annotated with the same reference symbols in these drawings.

FIG. 1 illustrates a schematic view of an electric drive unit having a lubrication and cooling circuit and an additional cooling circuit.

FIGS. 2 to 4 respectively illustrate a schematic view of an electric drive unit having a single lubrication and cooling circuit.

### DETAILED DESCRIPTION OF EMBODIMENTS

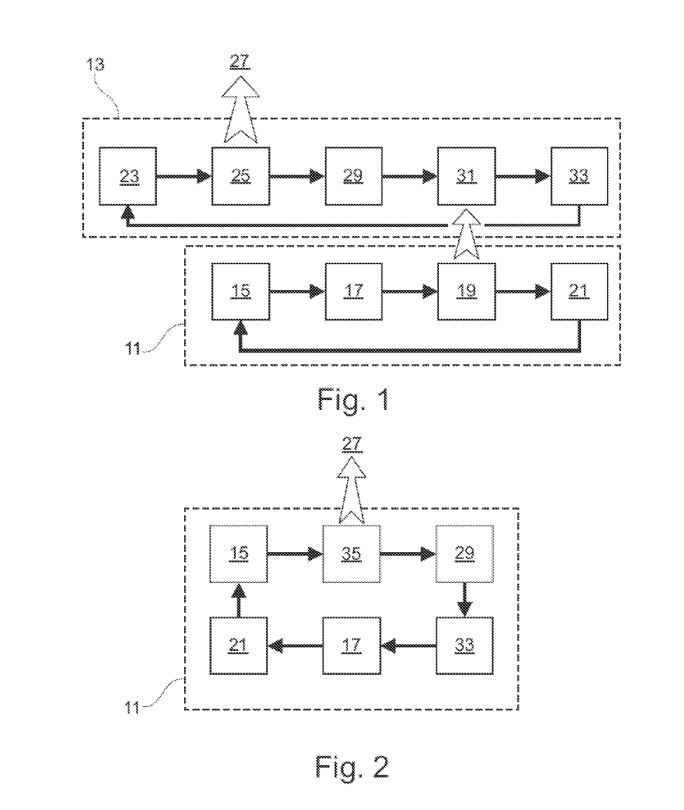

FIG. 1 illustrates an embodiment of an electric drive unit for a motor vehicle, which includes a lubrication and cooling circuit 11, which contains an aqueous lubricant. The aqueous lubricant can be a water-based lubricant. In addition, the electric drive unit includes a cooling circuit 13, which contains cooling water and is operated at a lower temperature level than the lubrication and cooling circuit 11. The electric drive unit is preferably an axle drive unit, and it includes an electric machine, for example, a polyphase asynchronous motor or a permanent-magnet synchronous machine, and a gearbox which is coupled to an output of the electric machine. The lubrication and cooling circuit 11 with the aqueous coolant is used to cool and lubricate parts of the electric machine and of the gearbox, while the cooling circuit 13 is additionally used for cooling parts of the electric machine and of an associated electric switching device. This will be explained in detail in the following text.

The lubrication and cooling circuit 11 with the aqueous lubricant includes a lubricant feed device 15, which causes the aqueous lubricant to circulate continuously in the lubrication and cooling circuit 11. Initially, the aqueous lubricant is passed along the parts of the internal area 17 in the electric machine, preferably at least over the winding ends. In general, the aqueous lubricant in the internal area 17 of the electric machine can be passed along an inner envelope (circumferential) surface of the stator of the electric machine and/or along an outer envelope surface of the rotor and/or through axial and/or radial cooling channels in the rotor of the electric machine.

In the internal area 17 of the electric machine, the aqueous lubricant absorbs the majority of the waste heat from the electric machine. In this case, it is particularly advantageous that the water base of the aqueous lubricant results in a greater heat dissipation efficiency being achieved, since the water component has a high thermal capacity and a high thermal conductivity.

The aqueous lubricant which has been heated in this way is fed to a lubricant/cooling-water heat exchanger, to be precise the high-temperature side 19 of the heat exchanger. The waste heat which has been absorbed from the internal area 17 of the electric machine is emitted via this heat exchanger to the cooling circuit 13. The aqueous lubricant which has been cooled down in this way is then fed to parts of a gearbox 21 of the electric drive unit, for example to the tribological contact surfaces and bearings of an axle differential gearbox. The aqueous lubricant is then once again passed to the lubricant feed unit 15, in which case a lubricant sump can be provided (not illustrated), for example between the gearbox 21 and the lubricant feed device 15.

The cooling circuit 13 includes a dedicated cooling-water feed device 23 for the cooling water contained therein. This feeds the cooling water first of all to a cooling-water/surrounding-air heat exchanger 25, which emits the waste heat contained in the cooling water to the surrounding air/environment 27, for example via cooling laminates or cooling ribs. The cooling water which has been cooled down in this way is then passed along an electric switching device of the electric drive unit, for example along an inverter 29. After the inverter 29, the cooling water is passed along the low-temperature side 31 of the already mentioned lubricant/cooling-water heat exchanger, in order to absorb waste heat from the lubrication and cooling circuit 11. Finally, the cooling water in the cooling circuit 13 is also used to cool an outer face 33 of the electric machine, for example a cooling jacket, which surrounds or forms the outer envelope surface of the stator of the electric machine. Finally, the cooling water is once again passed to the cooling-water feed device 23, possibly via a sump (not illustrated).

The respective sequence of the various components in the lubrication and cooling circuit 11 and the various components in the cooling circuit 13 may also be interchanged.

The use of an aqueous lubricant in the lubrication and cooling circuit 11 for the internal area 17 of the electric machine achieves particularly efficient heat dissipation from the internal area 17. This results in the electric machine having an advantageously high power density. A further advantage of the embodiment illustrated in FIG. 1 is that the aqueous lubricant in the lubrication and cooling circuit 11 is at the same time used to lubricate parts of the gearbox 21, as a result of which there is no need for an additional lubrication circuit for this purpose. The use of a separate cooling circuit 13 ensures that a low temperature level is reliably maintained for the electric switching device, i.e., inverter 29, associated with the electric machine, in order to protect the electric switching device against overheating. Furthermore, the heat dissipation power for the electric machine is increased even further, since the (cooler) outer face 33 of the electric machine is additionally cooled.

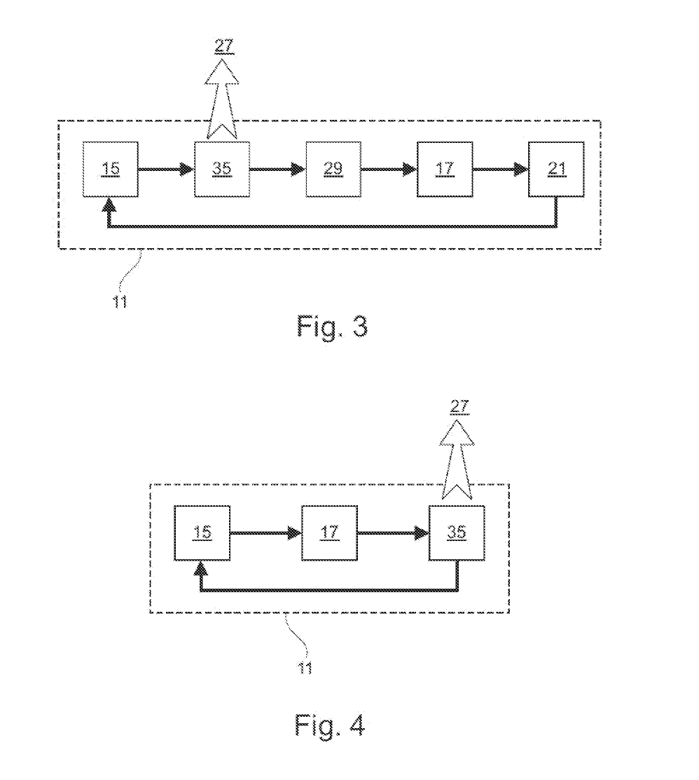

FIG. 2 illustrates an embodiment of an electric drive unit using a simple design than that illustrated in FIG. 1, and which includes only a lubrication and cooling circuit 11 having an aqueous lubricant. Meaning, in such an embodiment, no additional cooling circuit 13 with pure cooling water. A lubricant feed device 15 is also provided here. This feeds the aqueous lubricant initially to a lubricant/surrounding-air heat exchanger 35, from which the waste heat contained in the aqueous lubricant is emitted to the surrounding air/environment 27. The aqueous lubricant which has been cooled down in this way is then, that is to say at the lowest temperature level, passed along an electric switching device in the form of an inverter 29, in order to cool it. The aqueous lubricant is then passed along the outer face 33 of the electric machine (for example, the cooling jacket on the outer envelope surface of the stator).

After cooling the outer face 33 of the electric machine, the aqueous lubricant is used to cool the internal area 17 of the electric machine. For this purpose, the aqueous lubricant is, for example, passed along an inner envelope surface of the stator, along an outer envelope surface of the rotor and/or through axial and/or radial cooling channels in the rotor of the electric machine. In the process, a considerable proportion of the waste heat from the electric machine is absorbed, that is to say the aqueous lubricant now assumes the highest temperature level within the lubrication and cooling circuit 11.

Finally, the aqueous lubricant is also fed to, and thus lubricates, a gearbox 21 in the electric drive unit. From there, the aqueous lubricant is drawn into the lubricant feed device 15, and is once again pumped in the direction of the heat exchanger 35. A lubricant sump can be provided between the gearbox 21 and the lubricant feed device 15 and, in particular, can also be used as an additional heat exchanger for emission of heat to the surrounding air/environment 27.

One particular advantage of the embodiment illustrated in FIG. 2 is, furthermore, that use of an aqueous lubricant, which is passed through the internal area 17 of the electric machine, results in particularly efficient dissipation of the waste heat, thus allowing the electric machine to have a high power density. Furthermore, only a single cooling circuit 11 is provided. In particular, this is made possible by the fact that the aqueous lubricant is fed to the various cooling points in the sequence of the respectively desired temperature level. Meaning, the aqueous lubricant (at its lowest temperature level) is passed initially to the inverter 29, then to the outer face 33 of the electric machine, then (at its highest temperature level) to the internal area 17 of the electric machine, then to the gearbox 21, and then returns to the lubricant feed device 15.

FIG. 3 illustrates an embodiment of an electric drive unit having a further simplified design in comparison to that which is illustrated in FIGS. 1 and 2. The difference from the embodiment illustrated in FIG. 2 is that the aqueous lubricant is not passed along the outer face 33 of the electric machine, but only through the internal area 17 of the electric machine. This results in an even simpler physical design for the lubrication and cooling circuit 11, and in particular for the routing of the aqueous lubricant. Nevertheless, this ensures effective cooling of the electric machine, since the majority of the waste heat is extracted from the internal area 17 of the electric machine.

Finally, FIG. 4 illustrates an embodiment of an electric drive unit having an even further simplified design in comparison to that which is illustrated in FIGS. 1 to 3. The lubrication and cooling circuit 11 having the aqueous lubricant is used to cool only the active parts of the electric machine, such as the internal area 17, in order to effectively cool down the electric machine and thus, achieve a high efficiency for the operation of the electric machine. A lubricant feed device 15 and a lubricant/surrounding-air heat exchanger 35 are required for this purpose. However, in the embodiment illustrated in FIG. 4, no additional cooling is provided for an electric switching device, e.g., inverter 29, and no additional lubrication is provided for a gearbox 21.

Although embodiments have been described herein, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An electric drive unit for a motor vehicle, the electric drive unit comprising:
an electric motor including a rotor and a stator; and
a lubrication and cooling circuit configured for circulation through the electric motor, the lubrication and cooling circuit having a first fluid which is flows through and contacts an internal area of the electric motor to thereby lubricate and cool the internal area.

2. The electric drive unit of claim 1, wherein the first fluid flows through and contact at least one of:
an inner circumferential surface of the stator of the electric motor; and
an outer circumferential surface of at least one of the rotor, axial cooling channels of the rotor, and radial cooling channels of the rotor.

3. The electric drive unit of claim 1, further comprising an inverter.

4. The electric drive unit of claim 3, further comprising a second cooling circuit configured for circulation through the electric motor, the second cooling circuit having a second fluid which flows through and contacts at least one of the inverter and an outer circumferential surface of the stator of the electric motor.

5. The electric drive unit of claim 4, wherein:
the first fluid comprises a mixture of water and an alcohol; and
the second fluid comprises water.

6. The electric drive unit of claim 5, wherein the lubrication and cooling circuit and the second cooling circuit for the inverter are thermally coupled to one another via a heat exchanger.

7. The electric drive unit of claim 3, wherein the first fluid flows through and contacts an outer envelope surface of a stator of the electric motor, to thereby lubricate and cool the outer circumferential surface of the stator.

8. The electric drive unit of claim 1, further comprising a gearbox which is coupled to an output of the electric motor.

9. The electric drive unit of claim 8, wherein the first fluid flows through and contacts the operating parts of the gearbox to thereby lubricate and cool the gearbox.

10. The electric drive unit of claim 1, wherein the first fluid has a low electric conductivity such that it permits a continuous flow of electric current via at least one bearing of the electric motor.

11. The electric drive unit of claim 1, wherein the lubrication and cooling circuit includes a heat exchanger through which the first fluid emits heat to a surrounding area.

12. An electric drive unit for a motor vehicle, the electric drive unit comprising:
an electric motor including a rotor, a stator, an inverter and a gearbox;
a first fluid circuit configured to lubricate and cool a first predetermined area of the electric motor; and
a second fluid circuit configured to cool a second predetermined area of the electric motor,
wherein the second fluid circuit is operated at a lower temperature level than a temperature level of the first fluid circuit.

13. The electric drive unit of claim 12, wherein:
the first fluid circuit comprises a first fluid circuit feed device which circulates a first fluid continuously through the first fluid circuit, and a first fluid/air heat exchanger having a high temperature side and a low temperature side; and
the second fluid circuit comprises a second fluid circuit feed device which circulates a second fluid continuously through the second fluid circuit, and a second fluid/air heat exchanger.

14. The electric drive unit of claim 13, wherein the first fluid circuit and the second fluid circuit are thermally coupled to one another via the tow-temperature side of the first fluid/air heat exchanger.

15. The electric drive unit of claim 13, wherein the first predetermined area comprises at least one of:
an inner circumferential surface of the stator of the electric motor;
an outer circumferential surface of at least one of the rotor, axial cooling channels of the rotor, and radial cooling channels of the rotor; and
the gearbox.

16. The electric drive unit of claim 15, wherein the second predetermined area comprises at least one of:
the inverter; and
an outer circumferential surface of the stator of the electric motor.

17. The electric drive unit of claim 13, wherein:
the first fluid comprises a mixture of water and an alcohol and has a low electric conductivity such that it permits a continuous flow of electric current via at least one bearing of the electric motor; and
the second fluid comprises water.

18. An electric drive unit for a motor vehicle, the electric drive unit comprising:
an electric motor including a rotor, a stator, an inverter and a gearbox;
a first fluid circuit configured to lubricate and cool the electric motor, the first fluid circuit comprising a first fluid circuit feed device which circulates a first fluid continuously through the first fluid circuit, and a first fluid/air heat exchanger; and
a second fluid circuit configured to cool the electric motor, the second fluid circuit comprising a second fluid circuit feed device which circulates a second fluid continuously through the second fluid circuit, and a second fluid/air heat exchanger,
wherein:
the first fluid circuit extends continuously between the first fluid circuit feed device, at least one of the stator and the rotor, the first heat exchanger and the gearbox; and
the second fluid circuit extends continuously between the second fluid circuit feed device, the second heat exchanger, the inverter, the first heat exchanger and the stator.

19. The electric drive unit of claim 18, wherein:
the first fluid circuit and the second fluid circuit are thermally coupled to one another via the first fluid/air heat exchanger; and
the second cooling circuit receives heat emitted by the first cooling circuit at the first fluid/air heat exchanger.

20. The electric drive unit of claim 18, wherein:
the first fluid comprises a mixture of water and an alcohol and has a low electric conductivity such that it permits a continuous flow of electric current via at least one bearing of the electric motor; and
the second fluid comprises water.
